(19) United States
(12) Patent Application Publication
(10) Pub. No.: US 2019/0133105 A1
(43) Pub. Date: May 9, 2019

(54) SELECTIVELY TUNABLE ATTRACTION DEVICE

(71) Applicants: Richard Raymond Leach, Houston, TX (US); Roy Matthew Ringrose, Houston, TX (US); Gold Darr Hood, San Antonio, TX (US); Robert Lyle Hood, San Antonio, TX (US)

(72) Inventors: Richard Raymond Leach, Houston, TX (US); Roy Matthew Ringrose, Houston, TX (US); Gold Darr Hood, San Antonio, TX (US); Robert Lyle Hood, San Antonio, TX (US)

(73) Assignee: THE BOARD OF REGENTS OF THE UNIVERSITY OF TEXAS SYSTEM, Austin, TX (US)

(21) Appl. No.: 16/183,386

(22) Filed: Nov. 7, 2018

Related U.S. Application Data
(60) Provisional application No. 62/582,935, filed on Nov. 7, 2017.

(51) Int. Cl. A01M 1/04; A01M 23/38; A01M 23/36; A01M 1/22; A01M 1/10

(52) U.S. Cl. CPC A01M 1/04; A01M 23/38; H02S 20/30; A01M 1/223; A01M 1/10; A01M 23/36

(57) ABSTRACT

Certain embodiments are directed to device that use a Spectrum Modulated Frequency controlled LED source that strongly attracts a selected target insect or insect population to a trapping and/or killing system to facilitate the capture or disposal of selected genus of flying insects while limiting the attraction of other flying insects.

### PRIORITY

The present application claims priority to U.S. Provisional Application No. 62/582,935 filed Nov. 7, 2017, which is incorporated herein by reference in its entirety.

### BACKGROUND

Current devices use a variety of beacons, scents, or pheromones to attract animals or insects. However, these devices are not designed to target a specific genus, are indiscriminate in the attraction and/or capture and destruction of animals or insects, have a limited effectiveness against naturally occurring distractions in the region, and have a small radius of operation. Other alternatives include chemical control that results in problematic effects on crops and other organisms in the area. The continued use of chemicals can leave toxic residue in soils and subsequently contaminate groundwater. Thus, there remains a need for additional methods and devices for environmentally friendly animal or insect manipulation over a wider radius of operation.

### SUMMARY

Insects and other animals, such as birds, are able to see light wavelengths outside of the human visible spectrum. Nocturnal insects are often attracted to light sources that emit large amounts of broad spectrum radiation, and devices that exploit this behavior, such as light traps for forecasting pest outbreaks, and electric insect killers, have been developed. Embodiments of the invention are directed to a device emitting a modulated light spectrum to attract selected animals or insects. In certain aspects the animal or insect is a beneficial animal, such as bird, or insect. In certain aspects, the bird can be a predatory bird, such as a hawk. In other aspects the animal or insect is a harmful or noxious animal or insect. The device can employs a Spectrum Modulated Frequency controlled LED source that strongly attracts a selected genus/species of animal or insect. In certain aspects the insect is a harmful flying insect that is trapped and/or killed by the system, facilitating the control of a selected genus of flying insects while limiting the attraction of other flying insects, which may be neutral or beneficial. Other aspects attract beneficial animal or insect to the area. The selective device can attract/target over a significantly greater radius without use of toxins/poisons or indiscriminately targeting animals and/or insects.

The device can attract specific species of animal(s) and/or insect(s) leaving other species of animals and/or insects unaffected. Further, the device can provide for containment or elimination/disposal of harmful insects - the difference being applications of research (contain alive) or agricultural, health or annoyance (elimination). The LED combination for each species can be unique and crafted into its own program or cartridge, and presented in the same or different versions of a device. A desired target can be identified and its corresponding LED program/cartridge used, with the cartridges designed to be interchangable.

The device itself can be manufactured to take power from a standard outlet. However, it may be used with any power source. In particular, versions are available with solar and wind power, to better serve more remote locations and clients with a strong interest in green technology. For robust applications, the device can be made from steel and/or other durable materials. In certain aspects the device is design to withstand adverse weather conditions, such as a category III hurricane to better serve coastal and tropical island locations. Residential and other models can be fabricated with plastics or other materials appropriate for location of deployment. The device comprises a base/support, an attraction module, and a power supply. The base/support design is versatile and can be selected for the environment of use and a variety of applications, e.g., tripod, hanging, palletized, floating, etc.

In certain containment aspects, after luring in targeted genus/species, a containment unit uses either airflow to desiccate, electric current to kill, glueboard to trap, a live trap or other similar containment/extermination technologies. In certain aspects the device can be configured for population control or local extinction, the container may also use chopping blades to immediately kill insects. An added accessory can automatically empty the dead insects thus avoiding the handling of potentially diseased insects. These blades can be metal or plastic, 3D metal printing can be used to improve durability. Once pureed, the insect waste is dumped in intervals either onto ground (tripod design) or a containment unit to be disposed of or used as fertilizer. For research collections, the device can be configured with prepped container to provide for live storage.

Certain aspects can use LED lights alone or in unison to provide spectral signatures specific to the organism of interest. Other light-based attraction technologies use broadband light throughout the UV, visible, and near-infrared range, but do not use spectra specific to their species of interest. This approach attracts a diverse array of species, including many non-targeted in addition to the species of interest. Furthermore, the use of specific spectra enables a dramatic increase in the range of effect for a given amount of power relative to a broadband source. This property can be leveraged to either enhance the range or promote the longevity of remote use.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to all aspects of the invention. It is contemplated that any embodiment discussed herein can be implemented with respect to any method or composition of the invention, and vice versa. Furthermore, compositions and kits of the invention can be used to achieve methods of the invention.

The use of the word “a” or “an” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a chemical composition and/or method that “comprises” a list of elements (e.g., components or features or steps) is not necessarily limited to only those elements (or components or features or steps), but may include other elements (or components or features or steps) not expressly listed or inherent to the chemical composition and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a chemical composition and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1 shows a front view one example of a tripod base, solar powered insect collection device.

FIGS. 2A-B illustrate a perspective (A) and side (B) view of an airflow directive cone for pest suction into a containment vessel or receptacle. Large dotted arrow indicates airflow that can be generated using a fan integrated in the electronics/light source housing.

FIG. 3 illustrates a top, long side view, and short side view of one example of an electronic housing.

FIG. 4 illustrates an electronics schematic for solar charging including LED control and containment assistance electronics.

### DESCRIPTION

The following discussion is directed to various embodiments of the invention. The term “invention” is not intended to refer to any particular embodiment or otherwise limit the scope of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Most insects have two types of photoreceptive organs, compound eyes and ocelli. Compound eyes are made up of a large number of light-sensitive units termed ommatidia. An ommatidium contains an elongated bundle of photoreceptor cells, each having specific spectral sensitivities. The ommatidia are packed in a hexagonal array so as to cover a large visual field with certain spatial resolution and to perceive the motion of objects (Land and Nilsson 2002). The spectral sensitivities of photoreceptors determine the visible light wavelength for insects, which often expands into the ultraviolet (UV) region, which is invisible to humans. A compound eye typically contains three types of photoreceptor cells with spectral sensitivity peaking in the UV, blue, and green wavelength regions, respectively, as exemplified in honeybees (Menzel and Blakers 1976). Many insects can perceive UV light as a unique color (Koshitaka et al. 2008; von Helversen 1972).

It is well known that insects fly toward streetlamps or other outdoor illumination at night. This innate phototactic behavior has provided the basis of the design of electric insect killers. Equipped with broadband fluorescent tubes, the insect killers effectively attract insects such as moths and beetles. Light affects insect behavior and development in a variety of ways that can be divided into several categories. One of the most typical responses to light is phototaxis (Jander 1963). Insects exhibit the following phototactic behaviors: (A) attraction (positive phototaxis, moving toward a light source); this response can be used to trap pests, but the effective wavelengths and intensities vary among species (Coombe 1981; Hardie 1989; Kinoshita and Arikawa 2000; Menzel and Greggers 1985; Yang et al. 2003) and (B) repulsion (negative phototaxis, moving away from light); this can be used to prevent pests from entering a cultivation area by presenting light at wavelengths and intensities that repel them (Jander 1963; Kim et al. 2013; Reisenman et al. 1998).

Both human and avian eyes use two types of light receptors: rods and cones. Rods are sensitive to small quantities of light and are better for vision during the night. Cones detect specific wavelengths of light and are better suited for seeing color. Humans are trichromatic and have only three types of cones in their eyes, each having a distinctive response range of wavelengths with a maximum absorbance peak. By contrast, most birds are tetrachromatic, having four different types of cones. Some studies have also suggested that certain birds may be pentachromatic, having five different types of cones.

Color vision in birds can be categorized into two groups: violet sensitive (VS) and ultraviolet sensitive (UVS). Birds having UVS vision have a pigment in their cones that absorbs UV light, thereby allowing these birds to see into the UV spectrum. It is believed that the majority of avian species have UVS vision, including birds that are in the clades of palaeognathae (ratites and tinamous), charadriiformes (shorebirds, gulls, and alcids), trogoniformes (trogons), psittaciformes (parrots), and passeriformes (perching birds). (Ödeen , BMC Evol Blot 2013, 13:36). In nature, birds may take advantage of this UV vision through courtship (e.g., using UV reflective plumage to attract mates), hunting (e.g., tracking UV reflection of rodent waste), and other adaptations. This UV sensitivity can be exploited to selectively attract birds, such as eagles, owls, hawks, or falcons. In certain aspects, the light source can emit a wavelength in the range of 200 to 400 nm.

These responses to light are substantially influenced by a variety of factors, including light intensity and wavelength, combinations of wavelengths, time of exposure, direction of light source, and the contrast of light source intensity and color to that of ambient light.

This technology appeals to large (e.g., commercial scale) and small (e.g., residential scale) problems. Residential versions of the device (in development) can be sold directly to individual consumers, providing pest free yards or even portable relief, e.g., while camping. On the other end of the spectrum, entire cities or agencies (like the CDC) can use large versions of the device to stop outbreaks of contagions (i.e., Zika) rapidly in their tracks. Clients can be midsize businesses in the agricultural and recreational sectors. Crop infestations are a serious and expensive problem that the device can address without health risks or labor hours. Resort and recreational land owners may find that health and annoyance complications of insects may seriously impact their business, particularly in tropical geographies, and this device is quiet and effective.

Many animal or insect species are beneficial. In certain embodiments a device is used to attract beneficial animals or insects. In certain aspects the animal is a predatory animal or the insect is a predatory insect. As used herein, the term ‘predatory insect’ includes members of the family Coccinellidae (lady beetles) and Chrysopidae (green lacewings). For example, the term includes insects of the species, Coleomegilla maculata, and of the species Chrysoperla carnea. Certain wasps can be beneficial as well and play an important role in natural or biological control due to their propensity to prey on or parasitize various insect pests. Other beneficial insects include the spined soldier bugs among other true bugs (Suborder: Heteroptera), lacewings and ant lions (Order: Neuroptea), and dragonflies (Order: Odonata). Many species of insects are beneficial pollinators (e.g., bees, honeybees, solitary bees, and bumblebees (Order: Hymenoptera). Many of these beneficial insects also have well-developed vision. It would be advantageous to attract beneficial birds or insects to desired areas, for example to gardens or agricultural fields, via visual signal.

The device can be configured to attract predatory birds or predatory insects that prey on unwanted pests (e.g., rodents, birds, or insects). The device described herein can be used to attract predatory birds or insects to any area where their presence may be desired. The adult females and males are attracted and can themselves consume the prey. In addition, the female insects for example that are attracted to the area can lay eggs on the plants near prey, with the larval offspring then consuming the prey.

As used herein, the term “attract” includes both drawing animals or insects to an area, as well as retaining animals or insects in an area (e.g., increasing a local population) once they are there (e.g. due to reiterative drawing effects).

As used herein, the term “target area” includes any place where the presence of an attracted beneficial animal or insect may be desirable; or an area where the unwanted animal or insect is not desired and is targeted for containment or extermination, such as, for example, a residence, a yard, a farm field, a garden, or a horticultural or floricultural nursery.

In certain embodiments, a device can be configured to attract, capture, kill and/or store one or more of the identified (65+) specific genus of obnoxious flying insects in a variety of conditions useful for population control, research, etc. This is particularly effective for targeting insects that plague specific crops in agriculture, reducing/eliminating disease carrying insect populations in specific geographic zones including mosquito eradication or obtaining control samplings for research studies, as well as other ecosystem control projects. Also of interest is control of flying insects harmful to livestock in stockyards, barns, and stables. When strategically placed around agricultural plots, the unit provides a protective umbrella, preventing undesirable insects from reaching and damaging crops. This (agricultural clients) is an area of interest.

The term “insect trap” is used herein to include an insect trap or an insect station including at least one of the following: a modulatable light source, and a platform supporting the light source and other components. In certain aspects, the insect trap includes a container and/or kill mechanism (e.g., a blade or electrocution mechanism).

An embodiment of the present invention is an insect station that can be used in indoor and outdoor locations, the station emitting a selected wave length(s) of light. The source of light can be a light emitting diode (“LED”) with a wavelength between 200, 250, 300, 350, 400, 450, 500 to 600, 650, 700, 750, 800, 850, 900, 950, 1000, 1100, 1200 nm, including all values and ranges there between. In particular aspects, the wavelength is between 200 to 800 nm, 200 to 400 nm, or 300 to 500 nm including all values and ranges there between. Various wavelengths and phases of light can be used in combination to tune the attraction to a target animal, insect or insect population. Attraction is selected based on characteristics of the light, see for example Table 1.

TABLE 1
Species selective wavelengths.

| Species | Wavelength |
|---|---|
| Chironomidae | 295-305 nm |
| Scelionidae | 527-533 nm |
| Apis | 432-437 nm |
| Mosquitos (such as those important for vector control, | 390-400 nm |
| namely Aegis Egypti and Aedes Albopictus) | |
| Mlichiidae | 468-463 nm |

Furthermore, the light source can be powered with solar power, batteries, or batteries charged by solar or wind power. The use of batteries allows the station to be portable and used in locations where power outlets are not available. In order to save battery power, the LEDs could be pulsed or otherwise turned on and off, however, any florescent properties of the bait would make the bait seem to constantly glow.

An embodiment of the present invention is an insect station including a tunable light source. An insect station can use an electric zapper or a mechanical glueboard or other mechanism to kill or trap flying insects.

An example of a station or device is shown in the figures. The figures show a smaller residential configuration. Each configuration can have a tunable light source on platform that can, but not necessarily, includes a collection or kill mechanism. In certain aspects, a device includes a tripod base or support. The base or support need not be a tripod but can include, but is not limited to cylindrical, rectangular, cuboidal, or other polygonal support structure, a hanging structure, and the like as long as there is support for the light source and/or any collection or kill mechanism that may be present. The station or platform can be operatively connected to a solar panel to supply power or charge an associated battery, or both. A solar panel can be attached to the platform. A battery can be positioned within a cavity of the support or otherwise attached to the platform. Alternatively, a power cord could be used in lieu of a battery. A collection or kill mechanism can be positioned below the light source.

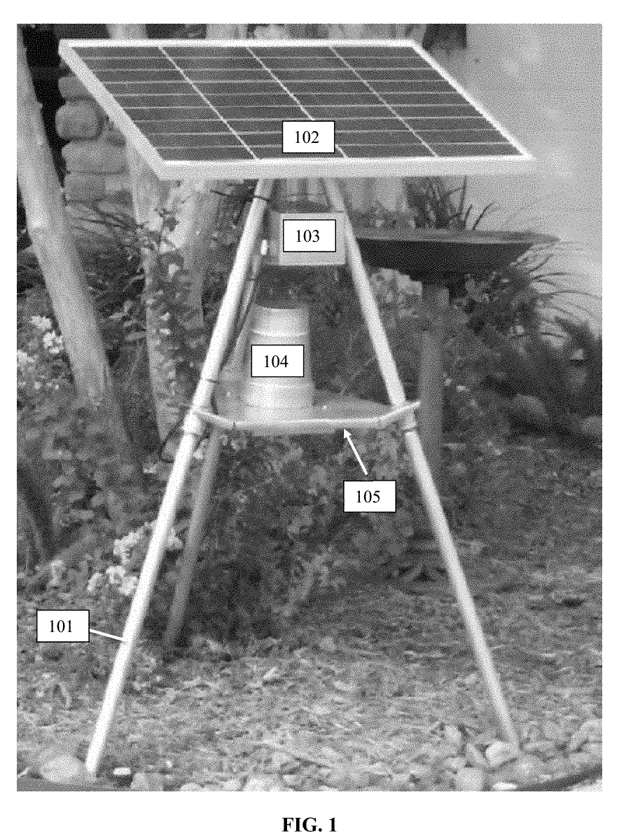

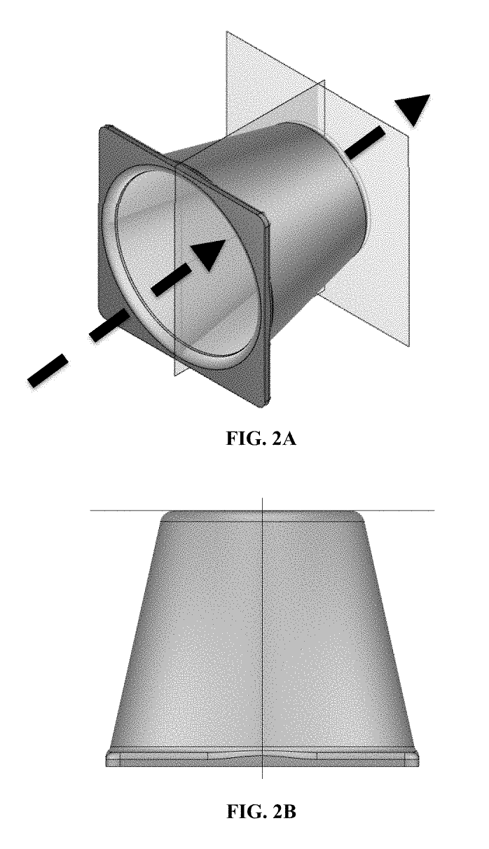

FIG. 1 illustrates an example of one embodiment of a device described herein. This embodiment has a tripod base 101 supporting a solar panel power source 102 that directly or indirectly through a rechargeable battery that powers a light source. The light source and optional fan or extermination mechanism is housed in electronics housing 103. The electronics housing can include a light source coupled to a controller to modulate light source output, as well an optional fan(s) configured to direct and/or kill pest. Other extermination mechanisms can be incorporated into the electronics housing. The device is configured with a containment vessel 104 supported by platform 105. In certain aspects, base 101 can be steel tubular legs with rapid screw removal access for durability and maintainability. In other aspects solar panel 102 can be mounted and connected tremote power. Solar panel can be sized and manufactured based on custom power requirements and may be rigid or flexible. Electronics control box or housing 103 can have an LED array mounted and configured to provide a light source. This can house the hardware required for device functionality, provides heat venting and weatherability, as well as a mounting point for 360 degree viewing of the LED source light output. Containment vessel 104 can be configured to include an air funnel, see FIG. 2, which can be used to accelerate the flow of air from the region of attraction near the lights to an intake fan. Platform 105 can provide structural support for legs as well as a mounting platform for an intake fan or other components. A collection device (bag or cup) may be mounted underneath. The funnel and fan components may be replaced by electrically charged “zappers”, if preferred by user.

FIG. 2 illustrates a cone configured for pest suction into a containment vessel or receptacle. In certain instances the containment vessel or receptacle is a bag, jar, cup, or other type of receptacle. In certain embodiment the cone empties exterminated pest to the ground or area surrounding the device. FIG. 2A shows an easy screw design with corner tab for screws or other attachment mechanisms to affix the cone directly onto fan base. FIG. 2B shows an external view of a cone shaped feature used to accelerate airflow near the top opening. The internal design of this cone can contain grooves, similar to barrel rifling, to keep particulates (e.g., insects) in the center of the airflow and further accelerate wind speed.

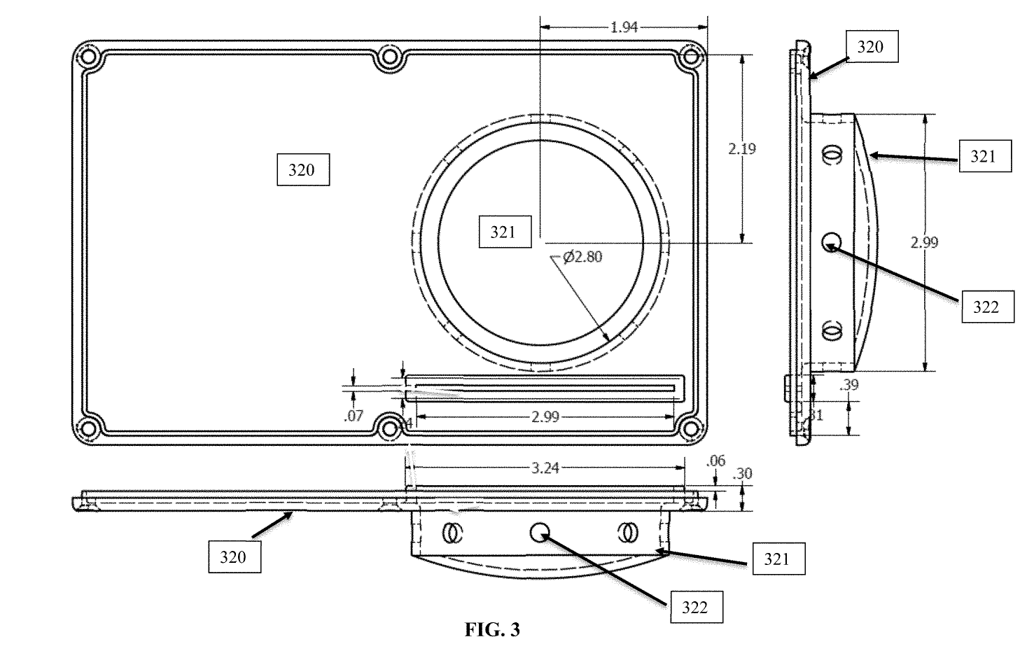

FIG. 3 illustrates a lid design. The lid having a base 320 and a raised portion 321 configured to house a light source. The raised portion comprises illumination openings 322 to provide for dispersing of the light from the light source to the environment around the device. Base 320 is a baseplate design for structural support to hold the battery, control chips, and other hardware. Raised portion 321 is a built in dome shape to provide 360 degree dropped/raised viewing housing for LEDs. Openings 322 to allow for LED mounting while protecting internal components.

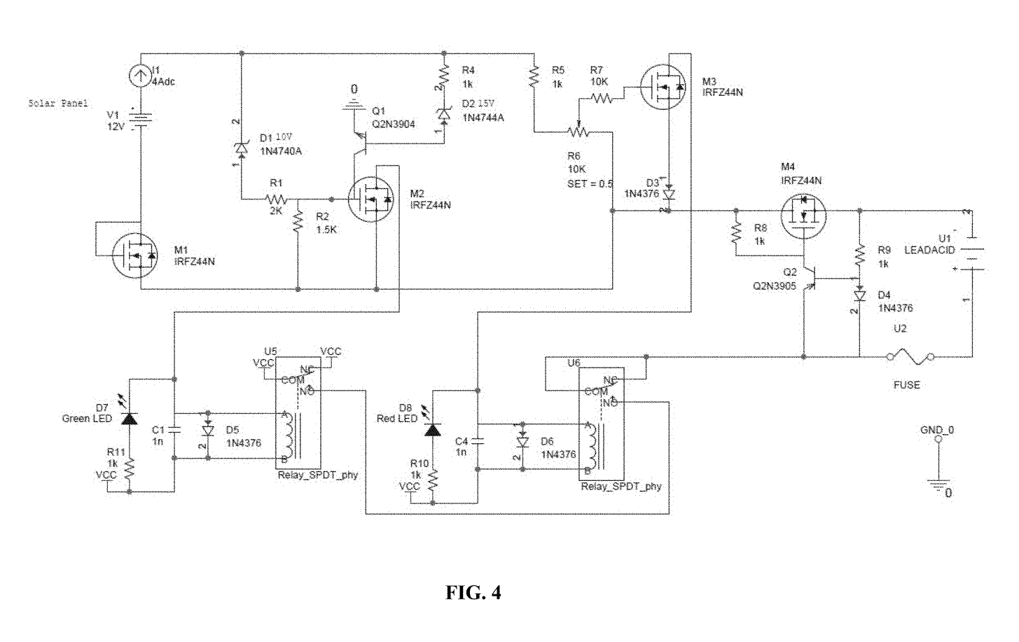

FIG. 4 is an example of a schematic for electronics of the device for solar charging, illumination, and containment. This schematic illustrates a prototype for a solar rechargeable LED and fan powering circuit to attract and contain flying targets of interest. LEDs may be powered with specific amperage/voltage requirements or power to specific bulbs can be directed with the use of a supplementary control board.

An embodiment of the present invention is using a tunable light station or device. In certain aspects the station/device can be portable or moveable. In certain instances, the relatively small amount of light required can be battery powered. The station can include at least 1, 2, 3, 4, 5, 6, 7, 8, 9, 10 or more LEDs or tunable LEDs, configured to attract one or more animal or insect. In other embodiments, an insect permeable cover can be operatively connected to the platform and/or tunable light source. The cover can include openings or slots to allow insects to enter the station and/or containment vessel.

1. A genus/species selective attraction device comprising light source, the light source being configured to emit a specific spectrum of one or more wavelengths selected to specifically attract a targeted animal and/or insect population.

2. The device of claim 1, wherein the light source is configured to selectively attract beneficial animals or insects.

3. The device of claim 2, wherein the beneficial animals are birds or bats.

4. The device of claim 3, wherein the beneficial birds are predatory birds.

5. The device of claim 4, wherein the predatory birds are hawks or falcons.

6. The device of claim 1, wherein the light source is configured to selectively attract harmful insects.

7. The device of claim 6, further comprising a platform configure to trap or kill the harmful insects.

8. The device of claim 7, further comprising a collection compartment.

9. The device of claim 7, further comprising an insect kill mechanism.

10. The device of claim 9, wherein the insect kill mechanism is a blade or electrified surface.

11. The device of claim 1, wherein the light source comprises a light emitting diode (LED).

12. The device of claim 1 further comprising a power source.

13. The device of claim 12, wherein the power source is a solar power source.

14. The device of claim 12, wherein the power source is a battery.

15. The device of claim 12, wherein the power source is a public electricity grid.

16. The device of claim 1, wherein the platform is a tripod.

17. The device of claim 1, wherein the platform is 0.5 to 10 feet in height.
